(19) United States
(12) Patent Application Publication
(10) Pub. No.: US 2002/0159099 A1
(43) Pub. Date: Oct. 31, 2002

(54) Optical scanner

(76) Inventors: Yin-Chun Huang, Hsinchu (TW); Huang Chih-Wen, Hsinchu (TW)

Correspondence Address: BACON & THOMAS, PLLC, 4th Floor, 625 Slaters Lane, Alexandria, VA, 22314-1176, US

(21) Appl. No.: 09/842,851

(22) Filed: Apr. 27, 2001

(51) Int. Cl. H04N 1/04

(52) U.S. Cl. 358/494; 358/474

(57) ABSTRACT

An optical scanner consists of a plurality of linear scanning light sources, a plurality of scattering lens boards, a plurality of linear image capturing units and a plurality of converging lens boards. The linear scanning light sources and image capturing units are laid in a staggered fashion on a circuit board to form a plane about the size of the scanning object. The scattering lens boards scatter light for the light sources to project evenly on the scanning object. The converging lens boards converge image reflecting from the scanning object to facilitate the linear image capturing units to capture the object image.

### FIELD OF THE INVENTION

This invention relates to an optical scanner that is capable of capturing object image and particularly an optical scanner that employs a plurality of linear image capturing units arranged in a two dimensional plane to form a scanning zone for scanning object.

### BACKGROUND OF THE INVENTION

Optical scanner is a computer peripheral device that employs photoelectric conversion principle to convert a scanning object image to digital data. The scanning method mainly includes: projecting a scanning light source on a scanning object, using an image capturing unit (such as CCD/CIS) to capture object image, then employing photoelectric conversion principle to convert the image signals to digital signals and output to the computer for processing.

Referring to FIG. 1, an optical scanner adapted conventional technique generally consists of a document holding board 10 for holding a scanning object (such as a flat document 12) thereon and an optical chassis 20 located below the holding board 10 for scanning the image of the document 12. As the optical chassis 20 can read only one linear image of the document 12 at a time, to completely read the entire image of the document 12, a driving means 14 must be provided to drive the optical chassis 20 for scanning and reading the entire image data of the document 12.

Referring to FIG. 2, a conventional optical chassis 20 includes a linear light source 21, a plurality of reflection mirrors 22, a lens set 23 and a linear image capturing unit 24. The conventional linear light source 21 usually is a cold cathode tube which projects light on the document 12 to generate a reflection image. The reflection image reflects upon the reflection mirrors 22 (three sets of reflection mirror are shown as an example in the drawing) before reaching the lens set 23 which refracts the light to form an image on the linear image capturing unit 24. The image capturing unit 24 employs photoelectric conversion principle to convert the image signals to digital signals, thus complete the reading of one piece of linear image of the document 12. When the driving means 14 drives the optical chassis 20 moving and completing the reading of entire image data of the document 12, image data scanning for the document 12 is finished.

Conventional optical scanner has one big disadvantage in the design and construction that still exists at present, that is its great thickness. The main issues that cause the optical scanner not able to reduce the thickness are existence of the reflection mirrors, lens set and driving means. These elements take a lot of space in the scanner and result in great thickness, bulky size and heavy weight.

Referring to FIG. 3, the reflection mirrors 22 and lens set 23 located in the optical scanner 10 are mainly to provide an optical path AB for a relatively large width linear document 12 image AA′ to form an image on the linear image capturing unit 24 which has a smaller width BB′. For a piece of A4 document which has a width of 210 mm or A3 document which has a width of 297 mm, the linear image capturing units presently being used in most conventional optical scanners 10 have a length about between 40 mm to 60 mm. To the optical scanners which adapt conventional technique, as the length of the linear image capturing unit 24 is smaller than the width of the document 12, the reflection mirrors 22 and lens set 23 become necessary elements. Furthermore, the linear image capturing unit 24 adapted the conventional technique can read only one linear image data at a time from the document 12. To completely read the image data on a flat document 12, it needs the driving means 14 to move the linear image capturing unit 24 to perform scanning operation. Hence the driving means 14 also becomes one of the indispensable elements in the optical scanner.

### SUMMARY OF THE INVENTION

The primary object of this invention is to provide an image data reading process that can complete scanning of a plane document at once for increasing scanning speed.

Another object of this invention is to provide an optical scanner that has a smaller thickness for improving the portability and carrying convenience of the scanner.

The optical scanner according to this invention consists of a plurality of linear scanning light sources, a plurality of scattering lens boards, a plurality of linear image capturing units and a plurality of converging lens boards. The linear scanning light sources and image capturing units are laid in a staggered fashion on a circuit board to form a two dimensional scanning zone which has about same size of the scanning object.

The scattering lens boards and converging lens boards are integrally formed and bonded together. The scattering lens boards are located between the linear scanning light sources and scanning object for evenly projecting light of the linear scanning light sources on the scanning object. The converging lens boards are located between the linear image capturing units and scanning object for converging the reflecting image of the scanning object to the linear image capturing unit to perform object image capturing.

By means of aforesaid construction, when the optical scanner of this invention is in use for scanning the image of a document, every linear document image and its corresponding linear image capturing unit have the same length. When the linear image capturing unit captures the document image, it does not need the optical path provided by the reflection mirrors and lens set to perform scanning operation. Hence the linear image capturing units of this invention may be disposed closer to the scanning object thereby may result in an optical scanner with a much smaller thickness. As the linear image capturing units of this invention form a two dimensional scanning zone which has about same size of the scanning object, one scanning cycle can completely scan the image on the entire plane of the document without the need of the driving means to move the image capturing unit to perform scanning operation. As a result, a lot of scanning time will be saved.

The invention, as well as its many advantages, may be further understood by the following detailed description and drawings. The drawings are only to serve for reference and illustrative purpose, and do not intend to limit the scope of the present invention.

### BRIEF DESCRIPTION OF THE DRAWINGS

FIG. 1 is a schematic view of a conventional optical scanner.

FIG. 2 is a schematic view of the optical path of a conventional optical scanner.

FIG. 3 is a schematic view of the scanning optical path of an optical chassis.

FIG. 4 is a schematic sectional view of this invention.

FIG. 5 is a schematic view of the scanning zone of this invention.

FIG. 6 is a fragmentary schematic view of this invention in use, for scanning a plane document.

FIG. 7 is a pictorial view of the scattering lens boards and converging lens boards of this invention.

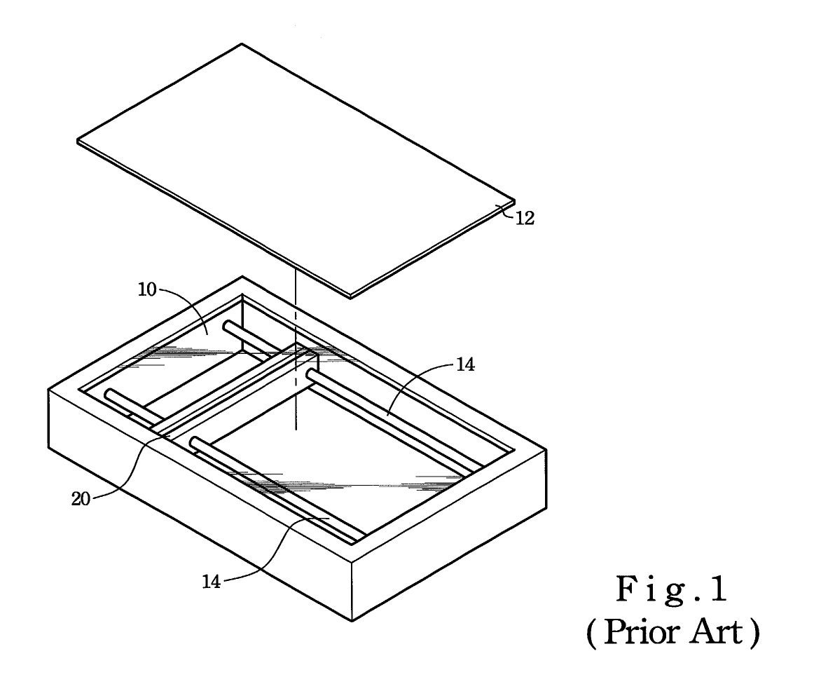

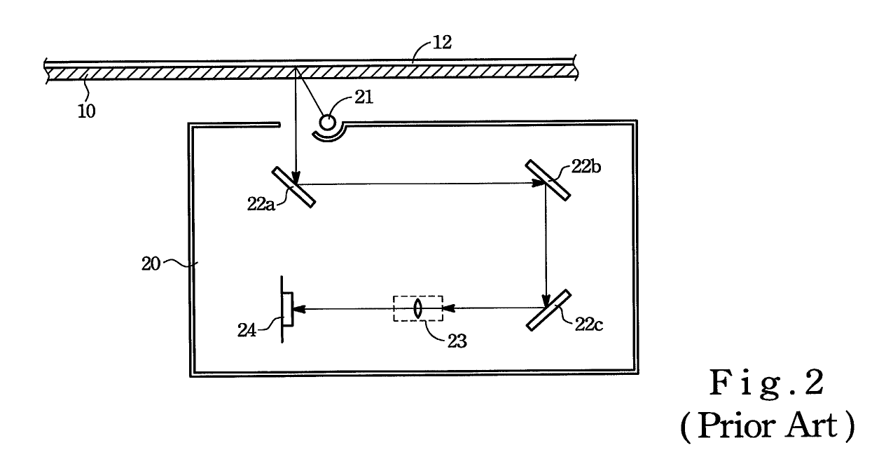

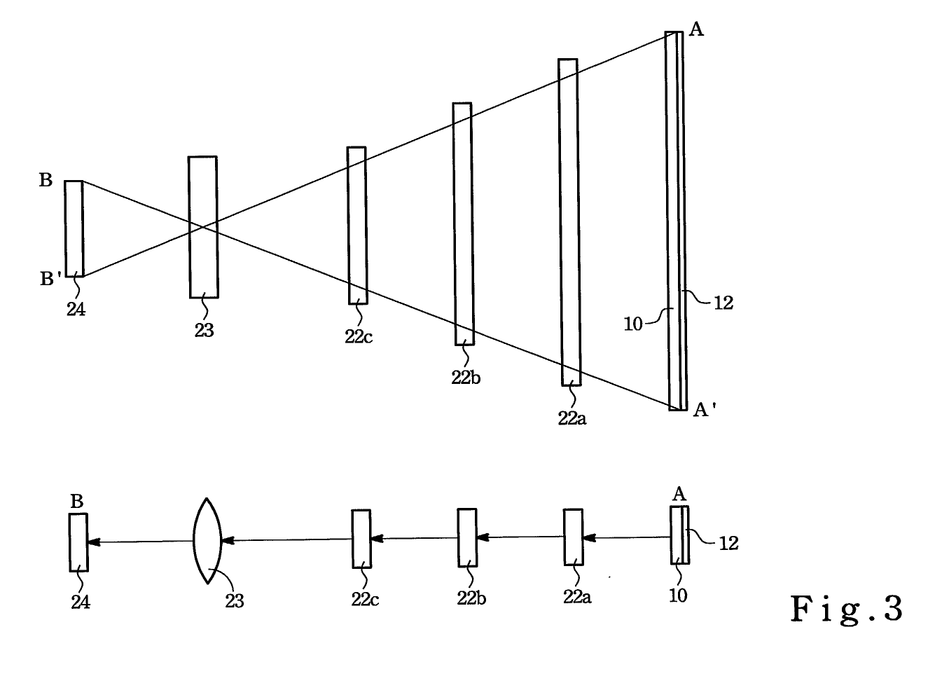

### DETAILED DESCRIPTION OF THE PREFERRED EMBODIMENT

This invention aims at providing an image capturing unit for optical scanner that mainly use a plurality of linear image capturing units which have same length as the scanning object to form a two dimensional scanning zone, and couple with suitable scanning light sources to enable the image capturing units scanning the scanning object directly without using reflection mirrors and lens set thereby to reduce the thickness of the optical scanner. Moreover, the two dimensional scanning zone has about same size of the scanning object thereby the optical scanner does not need a driving means, and can completely scan the entire flat document at once for reducing scanning time. More details will be elaborated by referring to the embodiment in the following:

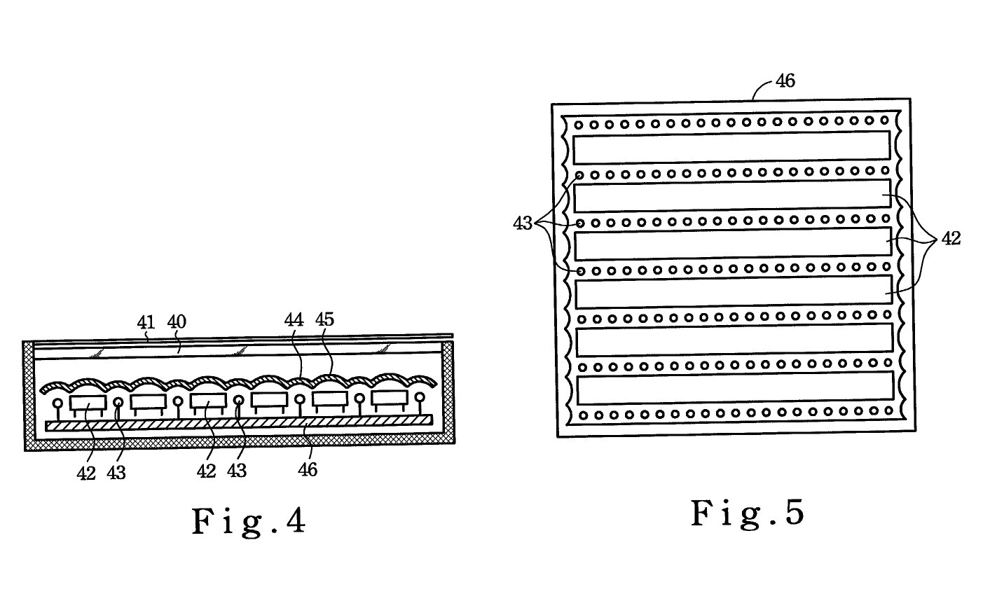

Referring to FIG. 4, the optical scanner according to this invention includes a document holding board 40 made of a transparent material (such as glass or acrylic) which may hold a scanning object (such as a flat document 41) thereon. Below the document holding board 40, there are a plurality of linear image capturing units 42, a plurality of linear scanning light sources 43, a plurality of scattering lens boards 44, a plurality of converging lens boards 45 and a circuit board 46.

Referring to FIG. 5, the linear image capturing units 42 may be CCD or CIS which have a length about the width of the flat document 41. The linear scanning light sources 43 consist of a plurality of Light Emitting Diodes (LED) which also have a length about the width of the flat document 41. The linear image capturing units 42 and linear scanning light sources 43 are laid in a staggered fashion on the circuit board 46 to form a two dimensional scanning zone which has about the size of the flat document 41.

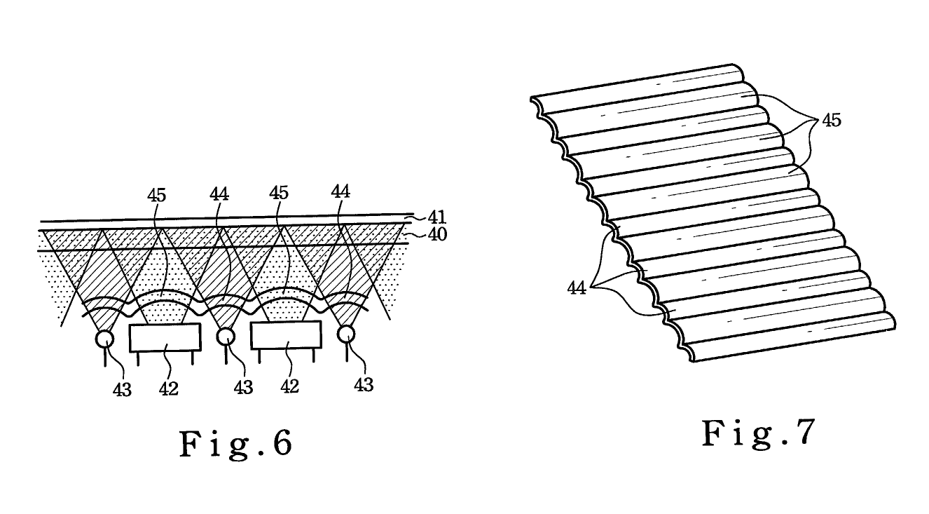

Referring to FIG. 6, the scattering lens boards 44 are located between the linear scanning light sources 43 and flat document 41 for scattering scanning light source and enabling the light source to project evenly on the corresponding flat document 41. The converging lens boards 45 are located between the linear image capturing units 42 and flat document 41 for projecting the reflecting image of the flat document 41 to the linear image capturing units 42 for image reading. There will be image overlap at two adjacent image capturing units 42. An accumulated averaging process may be adapted to obtain a better scanning image output. This is an art now commonly known, thus will be omitted herein. The scattering lens boards 44 and converging lens boards 45 are integrally formed and may be finished by CNC machining (as shown in FIG. 7).

When the optical scanner of this invention is in use for scanning a document, the scanning zone formed by the linear image capturing units directly faces to the flat document for scanning. As the scanning zone has about the size of the flat document, the entire document can be scanned completely at once rather than like conventional technique which uses a driving means to drive the linear image capturing unit moving and reading one linear document image at a time, and has to read all the linear document images to complete reading of one page of document image data. Hence this invention does not need the driving means and can complete scanning of a document image very quickly.

The linear image capturing unit of this invention has a length about the width of the scanning document, hence it can directly read the corresponding document image data without using the reflection mirrors and lens as the conventional technique does. It therefore provides a desired optical path which enables the document image formed at the linear image capturing units of a shorter length. Because of this invention does not have the reflection mirrors and lens set, the liner image capturing units may be disposed closer to the scanning object, and the optical scanner may be made with a smaller thickness. Moreover, because of no reflection mirrors and lens set, the image distortion and deviation resulting from document image transmitting among the reflecting mirrors and lens set can be avoided. As a result, the scanning image obtained through this invention is much better than the one got by the conventional technique. Furthermore, since the linear image capturing units of this invention may be located closer to the scanning document, a less expensive LED light source may be used to replace the more expensive cold cathode tube. Thus this invention can generate a better quality scanning effect at a lower cost.

The optical scanner according to this invention may be designed for scanning a general A4 or A3 size flat document. In addition to the aforesaid advantages, it may equip other function like a commonly used scanner. The optical scanner of this invention may also be made in a size for scanning name cards. Coupling with memory and display devices, the scanner of this invention may become a digital name card binder. In the social gathering occasions with the name cards being exchanged among different parties, the optical scanner of this invention may be used to scan the receiving name cards and store in the memory, and may be used to display the inquired name card information. Utilization and carrying thus become more convenient, and the problem of losing name cards may also be avoided.

While the preferred embodiment of the invention have been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An optical scanner, comprising:
a plurality of linear scanning light sources for providing light sources needed to scan an object;
a plurality of scatter lens boards located between the scanning object and linear scanning light sources for the light sources to evenly projecting on the scanning object;
a plurality of linear image capturing units laid in a staggered fashion with the linear scanning light sources for reading the reflecting image of the scanning object; and
a plurality of converging lens boards located between the scanning object and linear image capturing units for converging the reflecting image of the scanning object to the linear image capturing units.

2. The optical scanner of claim 1, wherein the linear scanning light sources and linear image capturing units are laid in a staggered fashion on a circuit board to form a plane size about the size of the scanning object.

3. The optical scanner of claim 1, wherein the scattering lens boards and converging lens board are integrally formed and being made by CNC machining.

4. The optical scanner of claim 1, wherein the optical scanner has a holding board made of a transparent material for holding the scanning object.

5. The optical scanner of claim 1, wherein the linear scanning light sources constitute a plurality of LED light sources laid linearly.

6. The optical scanner of claim 1, wherein the linear image capturing units are CCD.

7. The optical scanner of claim 1, wherein the linear image capturing units are CIS.

8. The optical scanner of claim 1, wherein the linear scanning light sources emit light synchronously to perform scanning on the object, and the linear image capturing units synchronously capture the image reflecting from the object.

9. The optical scanner of claim 1, wherein the image overlapped at two adjacent linear image capturing units is processed by accumulated averaging method for obtaining an improved image output.
